(19) United States
(12) Patent Application Publication
(10) Pub. No.: US 2017/0166197 A1
(43) Pub. Date: Jun. 15, 2017

(54) BELT CONTROLLING DEVICE AND METHOD OF CONTROLLING BELT FOR HYBRID VEHICLE

(71) Applicant: HYUNDAI MOTOR COMPANY, Seoul (KR)

(72) Inventors: Hwa Yong JANG, Hwaseong-si (KR); Ki Hong KANG, Gwangmyeong-si (KR); Sung Il YOU, Gwacheon-si (KR); Hyun KIM, Hwaseong-si (KR); Yong Ug KIM, Anyang-si (KR); YoungMin KIM, Yongin-si (KR)

(21) Appl. No.: 15/266,579

(22) Filed: Sep. 15, 2016

(30) Foreign Application Priority Data
Dec. 10, 2015 (KR) 10-2015-0176343

(51) Int. Cl. B60W 20/40; B60K 25/02; B60K 6/26; B60K 6/46; F16H 7/08; F16H 7/12

(52) U.S. Cl. CPC B60W 20/40; F16H 7/08; F16H 7/12; B60K 6/26; B60K 6/46; B60K 25/02; F16H 2007/0865; F16H 2007/0876; F16H 2007/0885; F16H 2007/0882; Y10S 903/906; B60K 2006/268; B60Y 2200/92; B60Y 2300/188

(57) ABSTRACT

A method for controlling a belt connecting an engine and a hybrid integrated starter and generator (HSG) of a hybrid vehicle includes steps of: driving an engine of the hybrid vehicle; detecting a rotational speed of the engine and a rotational speed of the HSG; and controlling a tension of the belt connecting the engine and the HSG by using the rotational speed of the engine and the rotational speed of the HSG.

### CROSS-REFERENCE TO RELATED APPLICATION

This application claims the benefit of priority to Korean Patent Application No. 10-2015-0176343, filed in the Korean Intellectual Property Office on Dec. 10, 2015, the entirety of which is incorporated herein by reference.

### TECHNICAL FIELD

The present disclosure relates to a belt controlling device and method of controlling a belt for a hybrid vehicle.

### BACKGROUND

A hybrid vehicle is a vehicle that uses two or more different kinds of power sources, and is generally a vehicle that is driven by an engine that obtains a driving torque by burning fuel and a motor that obtains a driving torque from battery power.

Hybrid vehicles are divided into a series type, a parallel type and a complex-type according to a driving type, and are divided into a hard type and a mild type according to a power sharing ratio between an engine and a motor.

The mild type of hybrid electric vehicle (hereinafter referred to as a mild hybrid electric vehicle) uses a battery and a motor having a small capacity, different from the hard type of hybrid electric vehicle. In the case of the mild hybrid electric vehicle, a hybrid integrated starter and generator (HSG) is used instead of an alternator.

The mild hybrid electric vehicle does not provide a driving mode in which torque of a motor is used as main driving torque, but the HSG may assist torque of the engine according to running states of the vehicle and may charge a battery through regenerative braking. Accordingly, energy efficiency of the mild hybrid electric vehicle may be improved.

In the case of a general hybrid vehicle, the motor integrates a starter and a generator, and is used as an output power source. That is, the motor acts as the starter starting the engine and the generator charging the battery through the motion of the engine.

In the mild hybrid vehicle, a belt that connects the engine and the HSG is used for the purpose of power delivery. Also, when the engine is turned off and starting while coasting driving, the mild hybrid vehicle requires smooth interworking that not be recognized by the driver.

Therefore, the mild hybrid vehicle is required to sense a failure of the belt connecting the engine and the HSG, and optimally maintain tension of the belt.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to provide a belt controlling device and method of a hybrid vehicle having advantages of controlling the tension of the belt for connecting the engine and the HSG.

An exemplary embodiment in the present disclosure provides a method for controlling a belt connecting an engine and a hybrid integrated starter and generator (HSG) of a hybrid vehicle, the method including: driving an engine of the hybrid vehicle; detecting a rotational speed of the engine and a rotational speed of the HSG; and controlling a tension of the belt by using the rotational speed of the engine and the rotational speed of the HSG.

The step of controlling the tension of the belt may include determining that the tension of the belt is less than a predetermined value when a value obtained by subtracting the rotational speed of the HSG from the rotational speed of the engine is greater than a first reference value.

The method may further include increasing the tension of the belt by using an auto tensioner or a belt pulley.

The step of controlling the tension of the belt may include determining that the tension of the belt is greater than a predetermined value when a value obtained by subtracting the rotational speed of the HSG from the rotational speed of the engine is less than a second reference value.

The method may further include decreasing the tension of the belt by using an auto tensioner or a belt pulley.

The step of controlling the tension of the belt may include calculating a slip ratio of the belt by using the rotational speed of the engine and the rotational speed of the HSG; and determining that failure occurs in the HSG or the belt when the slip ratio is greater than a third reference value.

The step of driving the engine may include detecting driving information of the hybrid vehicle; and determining a driving state of the engine by using the driving information, and determining to control the tension of the belt when the engine is normally operated.

The driving information may include at least one selected from the group consisting of a driving speed of the vehicle, an opening degree of an accelerator position sensor, a coolant temperature, and an external air temperature.

An exemplary embodiment in the present disclosure provides a device for controlling a belt of a hybrid vehicle including an engine and a hybrid integrated starter and generator (HSG) connected to the engine, including: a detector configured to detect a rotational speed of the engine and a rotational speed of the HSG; and a controller configured to control a tension of the belt connecting the engine and the HSG by using the rotational speed of the engine and the rotational speed of the HSG.

The controller may include a diagnosis unit configured to diagnose whether the belt is abnormal by using at least one selected from the group consisting of the rotational speed of the engine, the rotational speed of the HSG, and a slip ratio of the belt.

The controller may further include a tension controller configured to increase or decrease the tension of the belt by using an auto tension or a belt pulley.

The tension controller may increase the tension of the belt when the tension of the belt is less than a predetermined value, where the tension of the belt is less than a predetermined value when a value obtained by subtracting the rotational speed of the HSG from the rotational speed of the engine is greater than a first reference value.

The tension controller may decrease the tension of the belt when the tension of the belt is greater than a predetermined value, where the tension of the belt is greater than a predetermined value when a value obtained by subtracting the rotational speed of the HSG from the rotational speed of the engine is less than a second reference value.

According to the present invention for achieving the object, by determining the connected status of the belt using the rotational speed of the engine, the rotational speed of the HSG, and the slip ratio, and controlling the tension of the belt using an auto tensioner or a belt pulley, it is possible to maintain the tension of the belt and improve fuel consumption.

### BRIEF DESCRIPTION OF THE DRAWINGS

FIG. 1 is a schematic diagram of a hybrid vehicle including a device controlling a belt of the hybrid vehicle according to an exemplary embodiment in the present disclosure.

FIG. 2 is a flowchart briefly showing a process for diagnosing a failure of a belt according to an exemplary embodiment.

FIG. 3 is a drawing showing a connection structure of an engine and an HSG through a belt according to an exemplary embodiment.

FIG. 4 is a flowchart showing a process for adjusting a tension of a belt according to an exemplary embodiment.

FIG. 5 is a drawing showing an example which a belt is loosely connected according to an exemplary embodiment.

FIG. 6 is a drawing showing an example for increasing the tension of the loosely connected belt in FIG. 5.

FIG. 7 is a drawing showing an example which the belt is tightly connected according to an exemplary embodiment.

FIG. 8 is a drawing showing an example for decreasing the tension of the tightly connected belt in FIG. 7.

### DETAILED DESCRIPTION OF THE EMBODIMENTS

In the following detailed description, only certain exemplary embodiments have been shown and described, simply by way of illustration. As those skilled in the art would realize, the described embodiments may be modified in various different ways, all without departing from the spirit or scope of the present invention.

Throughout the specification, unless explicitly described to the contrary, the word “comprise” and variations such as “comprises” or “comprising” will be understood to imply the inclusion of stated elements but not the exclusion of any other elements.

Parts indicated by like reference numerals are the same components throughout the specification.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles, and other alternative fuel vehicles (e.g., fuel derived from resources other than petroleum).

In addition, some methods may be executed by at least one controller. The term “controller” refers to a hardware device including a memory and a processor configured to execute one or more steps interpreted as an algorithm structure. The memory stores algorithm steps, and the processor specifically executes the algorithm steps to perform one or more processes to be described below.

Further, control logic of the present invention may be implemented by a non-transient computer-readable medium on a computer-readable means including executable program instructions executed by a processor, a controller, or the like. Examples of a computer-readable medium, although not restrictive, include ROMs, RAMs, CD-ROMs, magnetic tapes, floppy disks, flash drives, smart cards, and optical data storages. The computer-readable recording medium may be distributed in a network-connected computer system, and for example, may be stored and executed in a distributed manner by a telematics server or Controller Area Network (CAN).

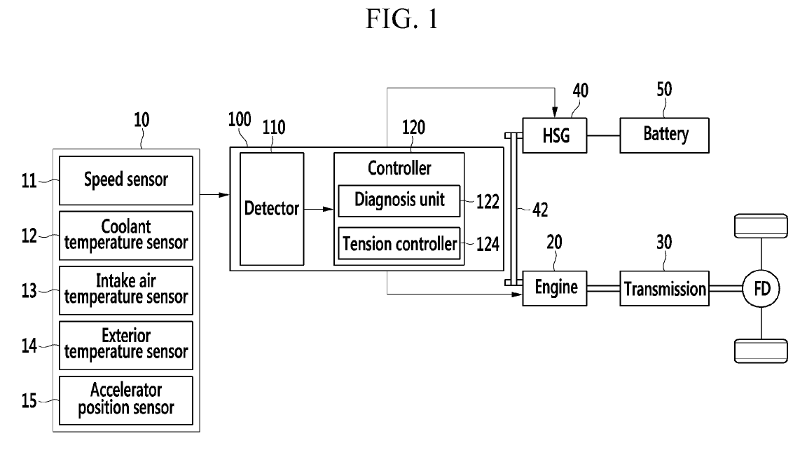

A device and method for controlling a belt of a hybrid vehicle will now be described with reference to FIG. 1 to FIG. 8.

FIG. 1 is a schematic diagram of a hybrid vehicle including a device controlling a belt of the hybrid vehicle according to an exemplary embodiment in the present disclosure. In this case, for convenience of explanation, a configuration of the device for controlling a belt of a hybrid vehicle according to the exemplary embodiment is schematically illustrated, but the diesel engine is not limited thereto.

As shown in FIG. 1, the hybrid vehicle according to an exemplary embodiment includes a sensor unit 10, an engine 20, a transmission 30, a hybrid integrated starter and generator (HSG) 40, a battery 50, and the device for controlling a belt 100. Herein, the hybrid vehicle includes a mild hybrid vehicle according to an exemplary embodiment of the present invention. The hybrid integrated starter-generator may include a mild hybrid starter and generator (MHSG) according to another exemplary embodiment.

The sensor unit 10 detects data for controlling the belt of the hybrid vehicle, and the data detected from the sensor unit 10 is transmitted to the device for controlling a belt 100. The sensor unit 10 includes a speed sensor 11, a coolant temperature sensor 12, an intake air temperature sensor 13, an exterior temperature sensor 14, and an accelerator position sensor 15.

The speed sensor 11 detects a driving speed of the hybrid vehicle, a rotational speed of the engine 20, a rotational speed of the HSG 40. For example, the speed sensor 11 detects an engine speed according to a phase shift of a crankshaft or camshaft, and transmits corresponding signals to the device for controlling a belt 100.

The coolant temperature sensor 12 detects a coolant temperature variable depending on operation states of the engine, and transmits corresponding signals to the device for controlling a belt 100.

The intake air temperature sensor 13 detects an air temperature supplied to an intake manifold, and transmits corresponding signals to the device for controlling a belt 100.

The exterior temperature sensor 14 detects an external air temperature of the vehicle, and transmits corresponding signals to the device for controlling a belt 100.

The accelerator position sensor 15 detects a position of an accelerator stepped by a driver, and transmits corresponding signals to the device for controlling a belt 100.

The engine 20 outputs power as a power source in the turned-on state. The transmission 30 is provided as an automatic transmission (AMT) or a dual clutch transmission (DCT), and a random transmission level is selected according to a vehicle speed and a driving condition such that the transmission outputs a driving force to a driving wheel to maintain driving.

The HSG 40 is connected to the engine 20 through the belt 42. The HSG 40 connected to the engine 20 receives power from a battery through an inverter, and starts the engine 20 or assists the torque of the engine 20. The HSG 40 is operated as a generator in coasting driving to supply regeneration energy to the battery 50.

The battery 50 is electrically connected to the HSG 40 and stores a voltage for operating the HSG 40. The battery 50 supplies a driving voltage to the HSG 40 when assists output of the engine 20, and charges the voltage generated by the HSG 40 during regenerative braking. The battery 50 according to an exemplary embodiment may be a 48 V battery.

The belt controlling device 100 diagnoses the connected status of the belt 42 using a rotational speed of the engine 20, a rotational speed of the HSG 40, and a slip ratio of the belt.

The belt controlling device 100 compares a value obtained by subtracting the rotational speed the HSG 40 from the rotational speed of the engine 20 with a predetermined value. The belt controlling device 100 controls to increase or decrease the tension of the belt 42 according to the comparison result.

The belt controlling device 100 includes a detector 110 and a controller 120 according to an exemplary embodiment.

The detector 110 detects driving information of the hybrid vehicle and provides the driving information to the controller 120. Herein, the driving information includes at least one of a vehicle driving speed, an opening degree of an accelerator position sensor (APS), a coolant temperature and an external air temperature.

In addition, the detector 110 detects data for controlling the belt of the hybrid vehicle. The detector 110 detects the vehicle driving speed, the rotational speed of the engine 20, the rotational speed of the HSG 40 while the engine 20 is normally driven, and provides it to the controller 120.

The controller 120 controls the engine 20 and the HSG 40 of the hybrid vehicle based on the data provided from the detector 110. The controller 120 controls the tension of the belt 42 using the rotational speed of the engine 20 and the rotational speed of the HSG 40.

The controller 120 includes a diagnosis unit 122 and a tension controller 124 according to an exemplary embodiment.

The diagnosis unit 122 diagnoses the connected status of the belt 42 using the rotational speed of the engine 20, the rotational speed of the HSG 40, and the slip ratio of the belt.

The diagnosis unit 122 may calculates the slip ratio of the belt 42 using the rotational speed of the engine 20 and the rotational speed of the HSG 40, and determine the failure of the belt 42 using the calculated slip ratio.

In addition, the diagnosis unit 122 may determine an operating state of the engine using the driving information of the vehicle detected from the detector 110, and determine to control the tension of the belt when the engine is normally operated.

The tension controller 124 controls to increase or decrease the tension of the belt 42 using the rotational speed of the engine 20 and the rotational speed of the HSG 40. The tension controller 124 may increase or decrease the tension of the belt 42 using a tension adjusting device such as an auto tensioner or a belt pulley.

When a value obtained by subtracting the rotational speed of the HSG 40 from the rotational speed of the engine 20 is greater than a first reference value, the tension controller 124 determines that the tension of the belt is less than the predetermined value, and increases the tension of the belt.

When the value obtained by subtracting the rotational speed of the HSG 40 from the rotational speed of the engine 20 is less than a first reference value, the tension controller 124 determines that the tension of the belt is greater than the predetermined value, and decreases the tension of the belt.

For such an object, the controller 120 may be implemented with at least one processor operating by a predetermined program, and the predetermined program may be programmed to perform each step according to the belt controlling method according to an exemplary embodiment.

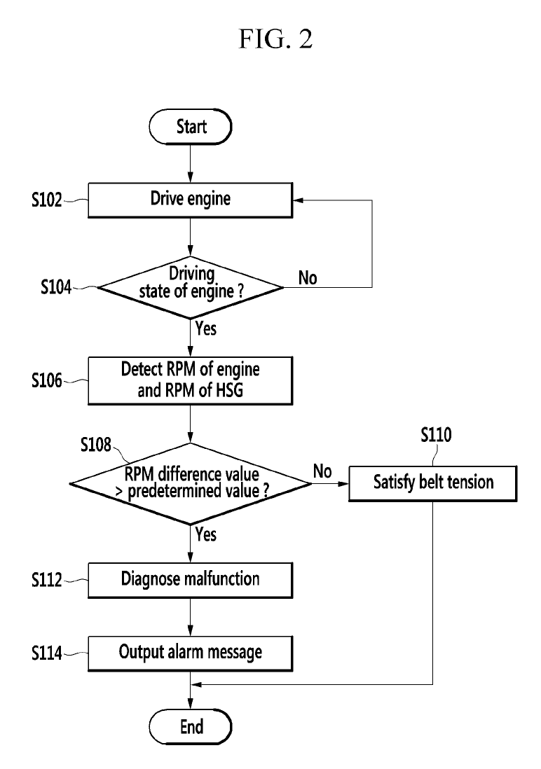

FIG. 2 is a flowchart briefly showing a process for diagnosing a failure of a belt according to an exemplary embodiment. The flowchart will be described with the same reference numerals as that of the configuration of FIG. 1.

Referring to FIG. 2, the belt controlling device drives the engine of the hybrid vehicle, and determines a driving state of the engine at steps S102 and S104.

The belt controlling device 100 determines the driving state of the engine using the driving information of the engine, and determines to control the tension of the belt when the engine is normally operated. Herein, the driving information includes at least one of the vehicle driving speed, the opening degree of the accelerator position sensor (APS), the coolant temperature, and the external air temperature.

The engine is normally operated when the vehicle driving speed and the opening degree are 0 (an idle state), and the coolant temperature and the external air temperature are greater than each of the predetermined value.

The belt controlling device 100 detects the RPM of the engine and RPM of the HSG at step S106.

The belt controlling device 100 diagnoses whether the belt is abnormal by comparing a difference between the RPM of the engine and the HSG with the reference value, or comparing the slip ratio with the reference value at step S108.

When a value obtained by subtracting the RPM of the HSG from the RPM of the engine is less than the reference value, or when the slip ratio is less than the reference value, it is determined that the tension of the belt is satisfied at step S110.

When the value obtained by subtracting the RPM of the HSG from the RPM of the engine is greater than the reference value, or when the slip ratio is greater than the reference value, the failure is occurred in the belt, and a warning message is outputted at steps S112 and S114.

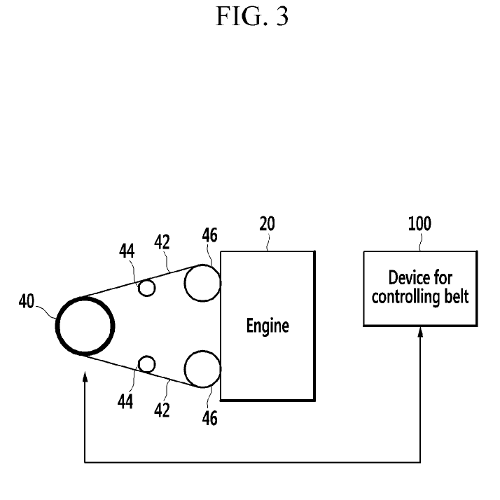

FIG. 3 is a drawing showing a connection structure of an engine and an HSG through a belt according to an exemplary embodiment.

Referring to FIG. 3, the belt controlling device 100 inspects the belt 42 for connecting the engine 20 and the HSG 40, and controls the tension of the belt 42 to maintain a reference value.

The belt controlling device 100 may detect the RPM of the engine 20 and RPM of the HSG 40, and control the tension of the belt 42 using the tension adjusting device such as an auto tensioner 44 or a belt pulley 46.

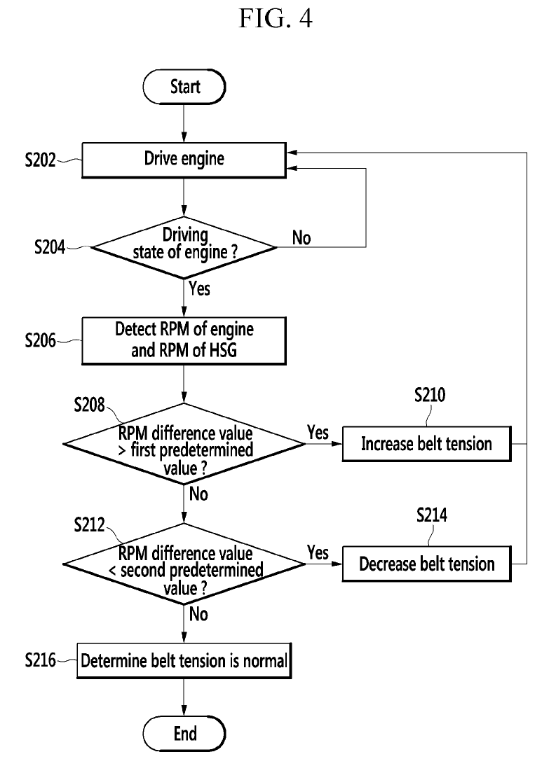

FIG. 4 is a flowchart briefly showing a process for adjusting a tension of a belt according to an exemplary embodiment in the present disclosure. The flowchart will be described with the same reference numerals as used in that of the configuration shown in FIG. 1.

Referring to FIG. 4, the belt controlling device 100 according to an exemplary embodiment in the present disclosure drives the engine of the hybrid vehicle, and determines the driving state of the engine at steps S202 and S204.

The belt controlling device 100 detects the RPM of the engine and the RPM of the HSG while driving the engine at step S206.

When a value obtained by subtracting the RPM of the HSG from the RPM of the engine is greater than a first reference value, the belt controlling device 100 determines that the belt is loosely connected at steps S208 and S210. The belt controlling device 100 increases the tension of the belt using the tension adjusting device such as the auto tensioner 44 or the belt pulley 46.

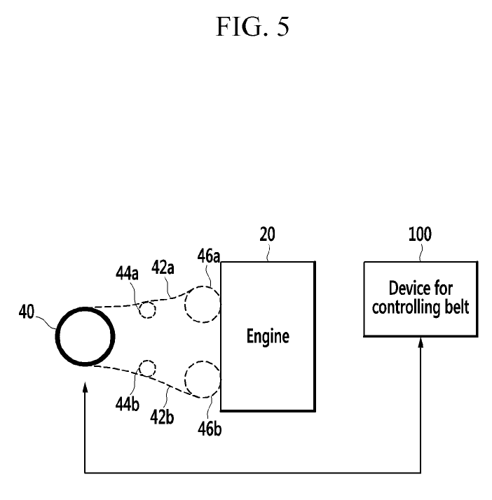

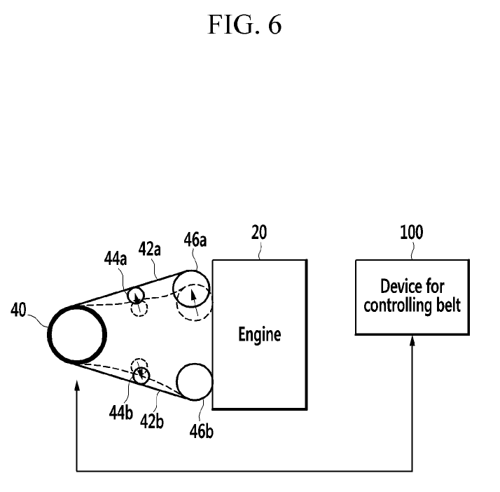

FIG. 5 is a drawing showing an example in which a belt 42a and 42b is loosely connected, and FIG. 6 is a drawing showing an example for increasing the tension of the loosely connected belt shown in FIG. 5.

Referring to FIG. 5, the belt controlling device 100 determines that the tension of the belt 42a and 42b is loosely connected when a value obtained by subtracting the RPM of the HSG 40 from the RPM of the engine 20 is greater than a first reference value.

Referring to FIG. 6, the belt controlling device 100 moves the belt pulley 46a to the outer side, and increases the tension of the belt 42a and 42b.

In addition, the belt controlling device 100 can move the auto tensioner 44a and 44b, as shown in FIG. 6, and increase the tension of the belt 42a and 42b.

The belt controlling device 100 compares the value obtained by subtracting the RPM of the HSG from the RPM of the engine with the second predetermined value when the value is less than the first predetermined value at step S212.

When the value obtained by subtracting the RPM of the HSG from the RPM of the engine is less than the second reference value, the belt controlling device 100 determines that the belt is tightly connected at step S214.

When the value obtained by subtracting the RPM of the HSG 40 from the RPM of the engine 20 is greater than the second reference value, the belt controlling device 100 determines that the tension of the belt is normally maintained at step S216.

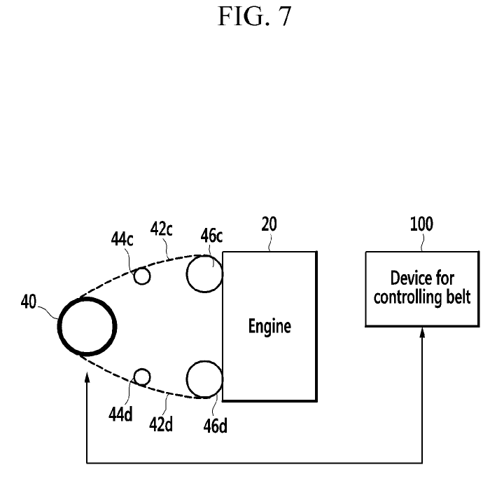

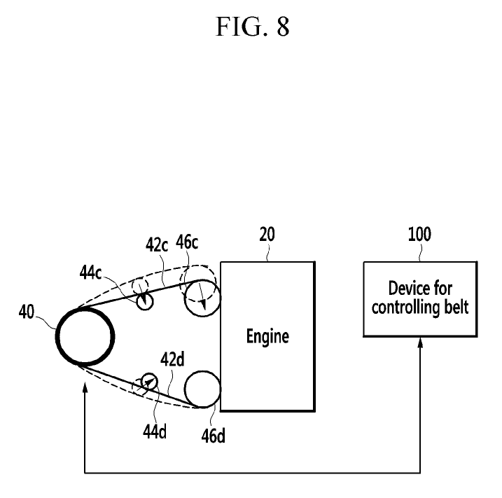

FIG. 7 is a drawing showing an example which the belt is tightly connected according to an exemplary embodiment, and FIG. 8 is a drawing showing an example for decreasing the tension of the tightly connected belt in FIG. 7.

Referring to FIG. 7, the belt controlling device 100 determines that the belt 42c and 42d is tightly connected when the value obtained by subtracting the RPM of the HSG 40 from the RPM of the engine 20 is less than the second reference value.

Referring to FIG. 8, the belt controlling device 100 moves the belt pulley 46c to an inside direction, and decreases the tension of the belt 42c and 42d.

In addition, the belt controlling device 100 can move the auto tensioner 44c and 44d, as shown in FIG. 8, and decrease the tension of the belt 42c and 42d.

As described, the belt controlling device and method of controlling a belt for a hybrid vehicle according to an exemplary embodiment in the present disclosure determines the connected status of the belt using the rotational speed of the engine, the rotational speed of the HSG, and the slip ratio, and controls the tension of the belt using an auto tensioner or a belt pulley. Therefore, it is possible to maintain the tension of the belt and improve fuel consumption.

The foregoing exemplary embodiments are not implemented only by an apparatus and a method, and therefore may be implemented by programs including functions corresponding to the configuration of the exemplary embodiment of the present invention or recording media on which the programs are recorded. Such recording media may be executed in a user terminal as well as a server.

While this invention has been described in connection with what are presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for controlling a belt connecting an engine and a hybrid integrated starter and generator (HSG) of a hybrid vehicle, the method comprising steps of:
driving an engine of the hybrid vehicle;
detecting a rotational speed of the engine and a rotational speed of the HSG; and
controlling a tension of the belt by using the rotational speed of the engine and the rotational speed of the HSG.

2. The method of claim 1, wherein
the step of controlling the tension of the belt includes a step of determining that the tension of the belt is less than a predetermined value when a value obtained by subtracting the rotational speed of the HSG from the rotational speed of the engine is greater than a first reference value.

3. The method of claim 2, further comprising:
a step of increasing the tension of the belt by using an auto tensioner or a belt pulley when the tension of the belt is less than the predetermined value.

4. The method of claim 1, wherein
the step of controlling tension of the belt includes determining that the tension of the belt is greater than a predetermined value when a value obtained by subtracting the rotational speed of the HSG from the rotational speed of the engine is less than a second reference value.

5. The method of claim 4, further comprising:
a step of decreasing the tension of the belt by using an auto tensioner or a belt pulley when the tension of the belt is greater than the predetermined value.

6. The method of claim 1, wherein
the step of controlling the tension of the belt includes steps of:
calculating a slip ratio of the belt by using the rotational speed of the engine and the rotational speed of the HSG; and
determining that a failure occurs in the HSG or the belt when the slip ratio is greater than a third reference value.

7. The method of claim 1, wherein
the step of driving the engine includes steps of:
detecting driving information of the hybrid vehicle; and
determining a driving state of the engine by using the driving information, and determining to control the tension of the belt when the engine is normally operated.

8. The method of claim 7, wherein
the driving information includes at least one selected from the group consisting of a driving speed of the vehicle, an opening degree of an accelerator position sensor, a coolant temperature, and an external air temperature.

9. A device for controlling a belt of a hybrid vehicle including an engine and a hybrid integrated starter and generator (HSG) connected to the engine, comprising:
a detector configured to detect a rotational speed of the engine and a rotational speed of the HSG; and
a controller configured to control a tension of the belt connecting the engine and the HSG by using the rotational speed of the engine and the rotational speed of the HSG.

10. The device of claim 9, wherein
the controller includes a diagnosis unit configured to diagnose whether the belt is abnormal by using at least one selected from the group consisting of the rotational speed of the engine, the rotational speed of the HSG, and a slip ratio of the belt.

11. The device of claim 10, wherein
the controller further includes a tension controller configured to increase or decrease the tension of the belt by using an auto tension or a belt pulley.

12. The device of claim 11, wherein
the tension controller increases the tension of the belt when the tension of the belt is less than a predetermined value, where the tension of the belt is less than a predetermined value when a value obtained by subtracting the rotational speed of the HSG from the rotational speed of the engine is greater than a first reference value.

13. The device of claim 12, wherein
the tension controller decreases the tension of the belt when the tension of the belt is greater than a predetermined value, where the tension of the belt is greater than a predetermined value when a value obtained by subtracting the rotational speed of the HSG from the rotational speed of the engine is less than a second reference value.
